(19) United States
(12) Patent Application Publication
(10) Pub. No.: US 2012/0245245 A1
(43) Pub. Date: Sep. 27, 2012

(54) Photoperoxidized Compositions and Methods of Making and Using Same

(75) Inventors: Olga Khabashesku, Houston, TX (US); Billy Ellis, Georgetown, TX (US)

(73) Assignee: Fina Technology, Inc., Houston, TX (US)

(21) Appl. No.: 13/071,650

(22) Filed: Mar. 25, 2011

(51) Int. Cl. C08J 3/28

(52) U.S. Cl. 522/34; 522/129; 522/63; 522/50

(57) ABSTRACT

A photoperoxidation process including irradiating a donor molecule with light from a light source to form an activated donor molecule, contacting the activated donor molecule with an acceptor molecule to form an activated acceptor molecule, and contacting the activated acceptor molecule with a diene elastomer in a vessel to form a singlet oxygen functionalized elastomer molecule. The singlet oxygen functionalized elastomer can be mixed with a styrenic monomer and subjected to a polymerization reaction to obtain a high impact polystyrene composition

### FIELD

The present invention is generally related to polymeric compositions having improved characteristics and methods of making and using same. More specifically, the present invention is related to the production of photoperoxidized polymeric compositions.

### BACKGROUND

Styrene, also known, as vinyl benzene, is an aromatic compound that is produced in industrial quantities, typically from ethyl benzene. Polystyrene is a well-known plastic made from the polymerization of the monomer styrene. Polystyrene is also one of the largest volume thermoplastic resins in commercial production today.

Polystyrene is often processed into many types of products, such as general purpose polystyrene (GPPS), high impact polystyrene (HIPS), transparent impact polystyrene (TIPS), and polystyrene foam. Many conditions affect the properties of the resulting product, including processing time, temperature, pressure, purity of the monomer feedstock, and the presence of additives or other compounds. These and other processing conditions alter the physical and chemical properties of the polystyrene product, affecting the suitability for a desired use.

Unmodified polystyrene, or GPPS, is well suited to applications where its brittleness is acceptable. For applications requiring less brittleness, polystyrene may be modified with toughening agents such as elastomers. Polystyrene modified with elastomers often exhibits improved impact properties and hardness, thus are commonly referred to as high impact polystyrene (HIPS). High impact polystyrene comprises polystyrene chains reinforced through crosslinks with the elastomer dispersed throughout the styrene polymer matrix. HIPS is useful in making molded articles and a variety of other applications including refrigerator linings, packaging applications, toys, furniture, point-of-purchase signs and displays, and food containers.

It is known in the art that HIPS compositions may be obtained either by physical blending of polystyrene with suitable elastomers like polybutadiene, or by mixing the elastomer with the monomeric styrene and graft polymerizing the mixture. These elastomer-reinforced polymers are commonly produced in either batch or continuous processes.

The physical characteristics and mechanical properties of HIPS are dependent upon many factors, including the particle size of the crosslinked rubber particles. The characteristics exhibited by at least some HIPS compositions including increased environmental stress crack resistance in the presence of fats, oils, or organic blowing agents, optical transparency or opacity, and high gloss.

The physical characteristics and mechanical properties of HIPS are also dependent upon the methods of HIPS production used. Current methods contain many disadvantages such as the additional cost associated with physically blending a polymerized product and the potential for degradation of the polymer due to the persistence of oxidizing agents in the product.

Photoperoxidation of rubber is a process that can be used to obtain HIPS having improved mechanical properties. However, some previously described photoperoxidation processes employ a loop reactor wherein feed is circulated for several hours. Such a process can have relatively high capital costs and high operational costs. It would be desirable to have a HIPS production process that produces a HIPS product having improved mechanical properties. It would also be desirable to have a HIPS production process that is more efficient and has lower operational costs.

### SUMMARY

In a non-limiting embodiment, either by itself or in combination with any other embodiment of the invention, is a photoperoxidation method that includes irradiating a donor molecule with light from a light source to form an activated donor molecule. The activated donor molecule is then contacted with an acceptor molecule to form an activated acceptor molecule. The activated acceptor molecule is then contacted with a diene elastomer in a vessel to form a singlet oxygen functionalized elastomer. The donor molecule can be a photosensitizer and the acceptor molecule can be molecular oxygen. The activated acceptor molecule can be singlet oxygen. The photosensitizer can be a photosensitive dye, such as selected from the group consisting of Rose Bengal, rhodamine B, erythrosin, eosin, fluorescein, methylene blue, acridine orange, and combinations thereof.

In a non-limiting embodiment, either by itself or in combination with any other embodiment of the invention, the light source can be selected from the group consisting of an ambient light source, a lamp capable of emitting light having wavelengths from 300 to 1400 nm, and a lamp capable of emitting light having wavelengths from 400 to 750 nm, and combinations thereof. The diene elastomer can be polybutadiene and can be present in the vessel in a styrenic monomer solution. The activated acceptor molecule can enter the vessel via a sparger positioned in the styrenic monomer solution. The sparger can have microporous air diffusers comprising pore sizes ranging from 0.1 to 20 microns. The vessel can be a reactor that includes an agitator. The invention can include polymerizing the singlet oxygen functionalized elastomer with a styrenic monomer solution to obtain a high impact polystyrene composition. The invention can include articles produced from the high impact polystyrene composition made by the method.

An alternate embodiment, either by itself or in combination with any other embodiment of the invention, is a high impact polystyrene production process that includes irradiating a photosensitive dye with light from a light source to form an activated photosensitive dye, and contacting the activated photosensitive dye with an oxygen containing gas to form singlet oxygen. The singlet oxygen is then contacted with a diene elastomer in a styrenic monomer solution in a vessel. A first stream that includes a singlet oxygen functionalized elastomer (SOFE) is removed from the vessel and subjected to polymerization to obtain a high impact polystyrene composition. The singlet oxygen enters the vessel via a sparger positioned in the styrenic monomer solution, the sparger having microporous air diffusers comprising pore sizes ranging from 0.1 to 20 microns. The vessel can include means for agitation of the contents.

The process can include combining the first stream with a second stream of diene monomer and a third stream of styrene monomer prior to the polymerization. The first stream can have a ratio of diene elastomer:SOFE ranging from 1:10 to 10:1.

In a non-limiting embodiment, either by itself or in combination with any other embodiment of the invention, the resulting high impact polystyrene composition can be produced in the absence of a peroxide initiator, and can have a higher grafting level than a polymer obtained by using a peroxide initiator. The invention includes the high impact polystyrene produced by the process, and any article made from the resulting high impact polystyrene.

Other possible embodiments include two or more of the above aspects of the invention. In an embodiment the method includes all of the above aspects and the various procedures can be carried out in any order.

### BRIEF DESCRIPTION OF DRAWINGS

FIG. 1 illustrates a prior art schematic of the photosensitization process.

FIG. 2 illustrates a schematic of an embodiment of the photosensitization process.

FIG. 3 illustrates a HIPS production process incorporating a photosensitization process.

FIG. 4 contains a photo of a CSTR photosensitization process without airflow and with agitation.

FIG. 5 is a photo of a CSTR photosensitization process with agitation and airflow.

FIG. 6 is a graph depicting polymerization results over time of 100% singlet oxygen functionalized elastomer (SOFE) feed, a 50:50 blend of SOFE:diene monomer feed, and a comparison feed containing an initiator.

### DETAILED DESCRIPTION

Disclosed herein are methods for the production of a polymeric composition containing a styrenic polymer and an elastomeric component. In an embodiment, the elastomeric component is subjected to singlet oxygen. Also disclosed herein are methods for the production of a polymeric composition containing a styrenic polymer and at least two elastomers. In an embodiment, at least one of the at least two elastomers is subjected to singlet oxygen and at least one of the at least two elastomers is prepared in the absence of singlet oxygen. Further disclosed herein is a photoperoxidation process of an elastomeric component. Also disclosed herein are polymeric compositions containing a photoperoxidized elastomeric component.

In an embodiment, the polymeric composition contains a styrenic polymer. In another embodiment, the styrenic polymer includes polymers of monovinylaromatic compounds, such as styrene, α-methylstyrene and ring-substituted styrenes. In an alternative embodiment, the styrenic polymer includes a homopolymer and/or copolymer of polystyrene. In a further embodiment, the styrenic polymer is polystyrene. In an embodiment, styrenic monomers for use in the styrenic polymer composition can be selected from the group of styrene, α-methylstyrene, vinyl toluene, p-methyl styrene, t-butyl styrene, o-chlorostyrene, vinyl pyridine, and any combinations thereof. The styrenic polymeric component in the blend of the present invention can be produced by any known process.

The polymeric composition of the present invention may contain any desired amounts of a styrenic polymer. In an embodiment, the polymeric composition contains at least 50 wt % of a styrenic polymer. In another embodiment, the polymeric composition contains a styrenic polymer in amounts ranging from 1 to 99.9 wt %, 10 to 99 wt %, and optionally 50 to 95 wt %. In a further embodiment, the polymeric composition contains a styrenic polymer in amounts ranging from 90 to 99 wt %.

General-purpose polystyrene (GPPS) that can be used in the present invention may have a melt flow rate (MFR) ranging from 1 to 40 g/10 min., optionally from 1.5 to 20 g/10 min., and optionally from 1.6 to 15 g/10 min. as determined in accordance with ASTM D-1238. In an embodiment, the GPPS may have a tensile strength ranging from 5,000 to 8,500 psi, optionally from 6,000 to 8,000 psi, and optionally from 6,200 to 7,700 psi as determined in accordance with ASTM D-638. In an embodiment, the GPPS may have a tensile modulus of from 400,000 to 500,000 psi, optionally from 420,000 to 450,000 psi, as determined in accordance with ASTM D-638. In an embodiment, the GPPS may have an elongation of from 0 to 4.0%, optionally of from 0 to 2.0%, optionally from 0.5 to 1.5% as determined in accordance with ASTM D-638. In an embodiment, the GPPS may have a flexural strength ranging from 10,000 to 15,000 psi, optionally from 11,000 to 14,500 psi, optionally from 11,500 to 14,200 psi as determined in accordance with ASTM D-790. In an embodiment, the GPPS may have a flexural modulus ranging from 400,000 to 500,000 psi, alternatively from 430,000 to 480,000 psi, as determined in accordance with ASTM D-790. In an embodiment, the GPPS may have an annealed heat distortion of from 185 to 220° F., optionally from 190 to 215° F., and optionally from 195 to 212° F. as determined in accordance with ASTM D-648. In an embodiment, the GPPS may have a Vicat softening point ranging 195 to 230° F., optionally from 200 to 228° F., and optionally from 205 to 225° F. as determined in accordance with ASTM D-1525.

In certain embodiments, the styrenic polymer is a styrenic copolymer containing styrene and one or more comonomers. In an embodiment, the one or more comonomers may include without limitation α-methylstyrene; halogenated styrenes; alkylated styrenes; acrylonitrile; esters of (meth)acrylic acid with alcohols having from 1 to 8 carbons; N-vinyl compounds such as vinylcarbazole, maleic anhydride; compounds which contain two polymerizable double bonds such as divinylbenzene or butanediol diacrylate; or combinations thereof. In an embodiment, the comonomer may be present in any desired amounts. The comonomer may be present in the styrenic copolymer in an amount ranging from 0.1 wt. % to 99.9 wt. % by total weight of the styrenic copolymer, alternatively from 1 wt. % to 90 wt. %, alternatively from 1 wt. % to 50 wt. %.

In an embodiment, the polymeric composition may also contain additives. The types and/or amounts of these additives may be chosen as deemed necessary in order to impart any desired physical properties, such as, increased gloss or color. In an embodiment, the additives include chain transfer agents, talc, antioxidants, UV stabilizers, photosensitive dye agent, and the like and any combinations thereof. In an embodiment, stabilizers or stabilization agents may be included to help protect the polymeric composition from degradation due to exposure to excessive temperatures and/or ultraviolet light. The additives may be added to the polymeric composition at any step or location along the process of producing the polymeric composition. In an embodiment, one or more additives may be added after recovery of the polymeric composition, for example during compounding such as pelletization. Alternatively or additionally to the inclusion of such additives in the styrenic polymer component of the polymeric composition, such additives may be added during formation of the polymeric composition or to one or more other components of the polymeric composition. In an embodiment, additives may be present in the polymeric composition in an amount of from 0.001 wt. % to 50 wt. %, alternatively from 0.01 wt. % to 10 wt. %, alternatively from 0.1 wt. % to 5 wt. % based on the total weight of the polymeric composition.

In an embodiment, the styrenic polymer contains an elastomeric component. In an embodiment, the elastomeric component is a diene elastomer, or diene-containing elastomer. In an embodiment, the diene elastomer contains conjugated diene monomers. In an embodiment, the conjugated diene monomers are selected from the group of 1,3-butadiene, 2-methyl-1,3-butadiene, 2-chloro-1,3 butadiene, 2-methyl-1,3-butadiene, 2-chloro-1,3-butadiene, and combinations thereof. In another embodiment, the diene elastomer contains aliphatic conjugated diene monomers. In an embodiment, the aliphatic conjugated diene monomers are selected from the group of C₄ to C₉ dienes, butadiene monomers, and combinations thereof. Blends of the homopolymers and/or copolymers of diene monomers may also be used in the elastomeric component. In an embodiment, the elastomeric component is a homopolymer of a diene monomer. In an alternative embodiment, the elastomeric component is polybutadiene.

In an embodiment, the elastomeric component includes polybutadiene, alternatively a combination of high and/or medium and/or low cis polybutadiene. As used herein, the term “high cis polybutadiene” refers to a polybutadiene having a cis content of at least 95%. As used herein, the term “low cis polybutadiene” refers to a polybutadiene having a cis content between 20 to 50%. Also as used herein, the term “medium cis polybutadiene” refers to a polybutadiene having a cis content between 50 and 95%. As used herein, “cis” refers to the stereoconfiguration of the individual butadiene monomers wherein the main polymer chain is on the same side of the carbon-carbon double bond contained in the polybutadiene backbone as is shown in Structure A:

### Structure A

Diene elastomers suitable for use in this disclosure may be further characterized by a low vinyl content. As used herein, “low vinyl content” refers to less than 5 wt. % of the elastomer having terminal double bonds of the type represented in Structure B:

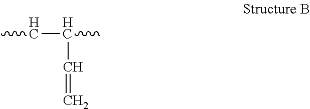

The diene elastomers may be prepared by any suitable means for the preparation of high and/or medium and/or low cis content diene elastomers. In an embodiment, the diene elastomers are prepared by a solution process using a transition metal or alkyl metal catalyst.

Examples of diene elastomers suitable for use in this disclosure include without limitation DIENE-55 (D-55) and Firestone-645 (F-645), both of which are commercially available from Firestone Tire and Rubber Company.

The diene elastomer may be present in amounts effective to produce one or more user-desired properties. In an embodiment, the amount of diene elastomer may depend on the amount of other elastomers present in the polymeric composition as will later be described in greater detail herein.

The high-impact polystyrene (HIPS) that can be made by the process of the present invention may have properties as listed herein, such as a melt flow rate ranging from 1 to 40 g/10 min., optionally from 1.5 to 20 g/10 min., and optionally from 2 to 15 g/10 min. as determined in accordance with ASTM D-1238. In an embodiment, the HIPS may have a falling dart impact ranging from 5 to 200 in-lb, optionally from 50 to 180 in-lb, and optionally from 100 to 150 in-lb as determined in accordance with ASTM D-3029. In an embodiment, the HIPS may have an Izod impact ranging from 0.4 to 5 ft-lbs/in, optionally from 1 to 4 ft-lbs/in, and optionally from 2 to 3.5 ft-lbs/in as determined in accordance with ASTM D-256. In an embodiment, the HIPS may have a tensile strength ranging from 2,000 to 10,000 psi, optionally from 2,800 to 8,000 psi, and optionally from 3,000 to 5,000 psi as determined in accordance with ASTM D-638. In an embodiment, the HIPS may have a tensile modulus ranging from 100,000 to 500,000 psi, optionally from 200,000 to 450,000 psi, and optionally from 250,000 to 380,000 psi as determined in accordance with ASTM D-638. In an embodiment, the HIPS may have an elongation ranging from 0.5 to 90%, optionally from 5 to 70%, and optionally from 35 to 60% as determined in accordance with ASTM D-638. In an embodiment, the HIPS may have a flexural strength ranging from 3,000 to 15,000 psi, optionally from 4,000 to 10,000 psi, and optionally from 6,000 to 9,000 psi as determined in accordance with ASTM D-790. In an embodiment, the HIPS may have a flexural modulus ranging from 200,000 to 500,000 psi, optionally from 230,000 to 400,000 psi, and optionally from 250,000 to 350,000 psi as determined in accordance with ASTM D-790. In an embodiment, the HIPS may have an annealed heat distortion ranging from 180 to 215° F., optionally from 185 to 210° F., and optionally from 190 to 205° F. as determined in accordance with ASTM D-648. In an embodiment, the HIPS may have a Vicat softening ranging from 195 to 225° F., optionally from 195 to 220° F., and optionally from 200 to 215° F. as determined in accordance with ASTM D-1525. In an embodiment, the HIPS may have a gloss 60° ranging from 30 to 100, optionally from 40 to 98, and optionally from 50 to 95 as determined in accordance with ASTM D-523.

In an embodiment, the polymeric component contains a singlet oxygen functionalized elastomer (SOFE). The SOFE may be prepared by allowing singlet oxygen to react with a substrate containing a hydrocarbon having at least one double bond to produce an oxidized substrate. A method of preparing a SOFE may include contacting a catalyst with molecular oxygen to generate an activated oxygen species and contacting the activated oxygen species with a hydrocarbon substrate.

In an embodiment, the SOFE may be obtained by first contacting molecular oxygen with a catalyst to generate an activated oxygen species followed by contacting the activated oxygen species with a hydrocarbon substrate. In an embodiment, the catalyst contains a photosensitizer. A photosensitizer, also referred to herein as “the donor”, refers to a light-absorbing material that may be photoexcited and used to create an excited state in another material, which is referred to herein as “the acceptor molecule.” For example, when the donor is exposed to a light source it may undergo photoexcitation and subsequently contact the acceptor molecules and transfer at least a portion of its energy to generate molecules having an excited electronic state.

In an embodiment, the donor includes any material whose excited state is at a higher energy than the acceptor and is capable of transferring energy to the acceptor. The donor, also referred to herein as a photosensitizer, refers to a light-absorbing substance that may be photoexcited and used to create an excited state in another molecule, which is also referred to as an acceptor molecule. In an alternative embodiment, the donor includes a photosensitive dye. In an embodiment, the photosensitive dyes include without limitation xanthene dyes, thiazine dyes, acridines, or combinations thereof. In another embodiment, the photosensitive dyes are selected from the group of Rose Bengal, rhodamine B, erythrosin, eosin, fluorescein, methylene blue, and acridine orange, and combinations thereof.

The catalyst may further contain a support material, or materials, supporting one or more donor materials such as a photosensitive dye. In an embodiment, the support material(s) may include talc, inorganic oxides, clays, clay minerals, ion-exchanged layered compounds, diatomaceous earth compounds, zeolites or a resinous support material, such as a polyolefin, or combinations thereof. In an alternative embodiment, the support material may include silica, alumina, or combinations thereof. The support material may be in the form of pellets and/or beads having any variety of shapes and/or sizes. In an embodiment, the support material for a photosensitizer may be a translucent material. In an embodiment, the support material contains silica having a surface area of equal to or greater than 100 m²/g, alternatively equal to or greater than 150 m²/g, alternatively equal to or greater than 500 m²/g. In another embodiment, the support material contains alumina having a surface area of equal to or greater than 200 m²/g, alternatively equal to or greater than 300 m²/g, alternatively equal to or greater than 400 m²/g.

In an embodiment, a catalyst containing a photosensitizer may be photoexcited by exposure to a light source and contacted with at least one acceptor molecule wherein at least some of the acceptor molecules become excited acceptor molecules. In an embodiment, the acceptor molecule includes molecular oxygen and the excited acceptor molecule includes singlet oxygen.

Singlet oxygen, which is designated as ¹O₂, refers to the two metastable states of molecular oxygen with a higher energy than the ground state, triplet oxygen. The two metastable states of ¹O₂ differ only in the spin and occupancy of oxygen's two degenerate antibonding n-orbitals. The O₂(b¹Σ_{g}⁺) excited state is very short lived and relaxes quickly to the lowest lying excited state, O₂(a¹Δ_{g}). Thus, the O₂(a¹Δ_{g}) state is commonly referred to as singlet oxygen. The obtained singlet oxygen may then be used to form the SOFEs described herein.

In an embodiment, the SOFE is selected from the group of peroxidized elastomers and hydroperoxidized elastomers, and combinations thereof. In another embodiment, the SOFE is selected from the group of peroxidized polybutadiene, and hydroperoxidized polybutadiene, and combinations thereof. Some methods for the preparation of SOFEs are disclosed in U.S. patent application Ser. No. 11/835,126 filed Aug. 7, 2007 and entitled “Singlet Oxygen Oxidized Materials and Methods of Making and Using Same,” which is incorporated by reference in its entirety.

The SOFE may be present in the polymeric composition in any desired or result-effective amounts. In an embodiment, the SOFE may be present in the polymeric composition in an amount ranging from 0.1 to 15 wt. % by total weight of the polymeric composition, alternatively from 2 to 10 wt. %, and alternatively from 5 to 8 wt. %.

In an embodiment, the polymeric composition contains SOFEs. In another embodiment, the polymeric composition contains a mixture of diene elastomers and SOFEs. In an embodiment wherein the polymeric composition contains a mixture of diene elastomers and SOFEs, the weight ratio of diene elastomer:SOFE present in the polymeric composition may be from 1:10 to 10:1, alternatively from 1:5 to 5:1, alternatively from 1:1 to 1:4, alternatively 1:2.5 to 1:3.5. In an embodiment, the weight percent of diene elastomer in the polymeric composition may be from 0.01 to 20 wt %, alternatively from 0.1 to 10 wt %, alternatively from 0.2 to 6 wt %, alternatively from 2 to 8 wt %. In an embodiment, the weight percent of the SOFE in the polymeric composition may be from 0.01 to 20 wt %, alternatively from 0.5 to 15 wt %, alternatively from 2 to 10 wt %, alternatively from 4 to 8 wt %.

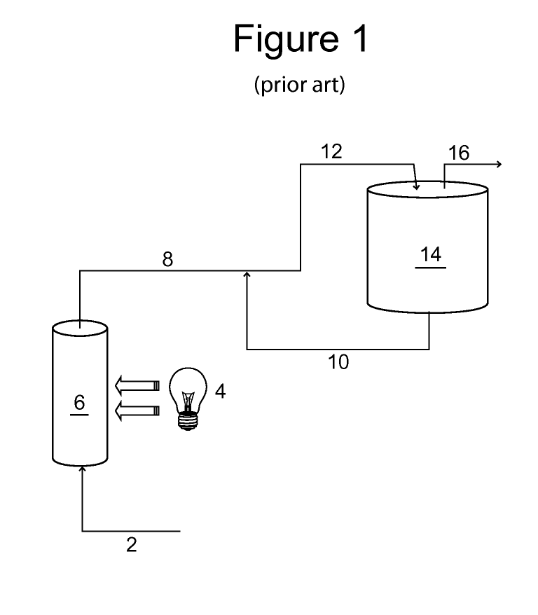

A prior art process scheme of preparing photoperoxidized rubber is depicted in FIG. 1. The process scheme depicted in FIG. 1 includes the steps of contacting a gaseous stream 2 with a light source 4. In an embodiment, the gaseous stream 2 refers to any oxygen containing gaseous stream. In another embodiment, the gaseous stream 2 is selected from the group of air, oxygen gas, and any other gas containing oxygen in its triplet state, and combinations thereof. In an embodiment, the light source 4 is any light source capable of transmitting light in the wavelength absorbed by the photosensitive dye and is effective to excite the photosensitive dye. In an embodiment, the light source 4 is selected from the group of an ambient light source, a lamp, such as a tungsten lamp, capable of emitting light having wavelengths from 300 to 1400 nm, and a lamp capable of emitting light having wavelengths from 400 to 750 nm, and combinations thereof.

The process scheme depicted in FIG. 1 includes contacting the oxygen containing gaseous stream 2 with the light source 4 in the presence of a photocatalyst. The photocatalyst includes a photosensitizer, or donor, and a support. The donor and support may be any donor or support of the types disclosed herein. In an embodiment, the photocatalyst is present in a dry catalyst column 6. In an embodiment, the dry catalyst column 6 contains at least two packed phototubes. The gaseous stream leaving the dry catalyst column, or singlet oxygen stream 8, is then contacted with an elastomer solution feed stream 10 to produce a singlet oxygen functionalized elastomer (SOFE) containing stream 12. In an embodiment, the elastomer solution feed stream 10 contains an elastomer dissolved in a solution containing styrene monomer, which is obtained in elastomer feed tank 14. The SOFE containing stream 12 is recycled to the elastomer feed tank 14 and a SOFE containing product stream 16 exits the elastomer feed tank 14.

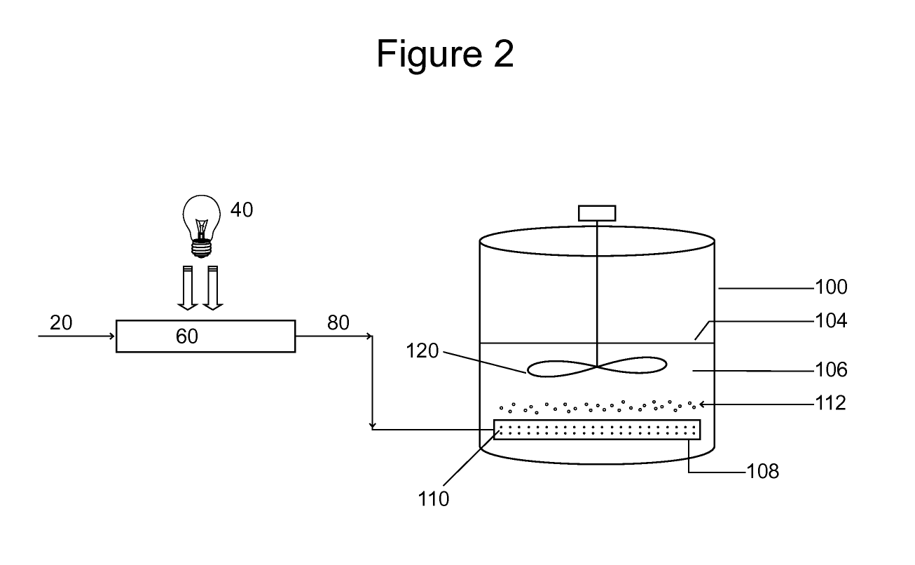

An embodiment of the present invention includes a process of preparing photoperoxidized rubber as depicted in FIG. 2. The embodiment depicted in FIG. 2 includes contacting an oxygen containing gaseous stream 20 with a light source 40 in the presence of a photocatalyst. In an embodiment, the photocatalyst includes a photosensitizer, or donor, and a support. The donor and support may be any donor or support of the types disclosed herein. In an embodiment, the photocatalyst is present in a dry catalyst column 60. In an embodiment, the dry catalyst column 60 contains at least two packed phototubes. The gaseous stream leaving the dry catalyst column, or singlet oxygen stream 80, is then sent to a sparger 108 positioned inside tank 100. In an embodiment, the sparger 108 is located underneath the liquid level 104 of solution 106, optionally near the bottom of tank 100. In an embodiment, the sparger 108 contains an array of microporous air diffusers 110, from which the singlet oxygen stream 80 exits into the solution 106 resulting in a large number of small bubbles 112 in the solution 106. In an embodiment, the tank optionally contains an agitator 120. The agitator 120 can be located above or below the sparger 108.

In an embodiment, the sparger 108 can be selected from any protrusion capable of fitting inside tank 100 and below the liquid level 104, wherein the sparger 108 can have any shape that is capable of containing an array of microporous air diffusers 110. In another embodiment, the sparger 108 can include a tube having a length that allows the tube to be placed horizontally, vertically, or at any angle in between, below the liquid level 104. In another embodiment, the sparger 108 can include a tube having a circular shape, optionally following the inner circumference of the tank. In a further embodiment, the tank 100 can contain any amount and combination of spargers 108.

In an embodiment, the sparger 108 is capable of supplying air, or other gaseous streams, at a rate ranging from 10 to 200 L/min. In another embodiment, the sparger 108 contains microporous air diffusers 110 having pore sizes ranging from 0.1 to 20 microns. In a further embodiment, the pore sizes range from 0.5 to 15 microns.

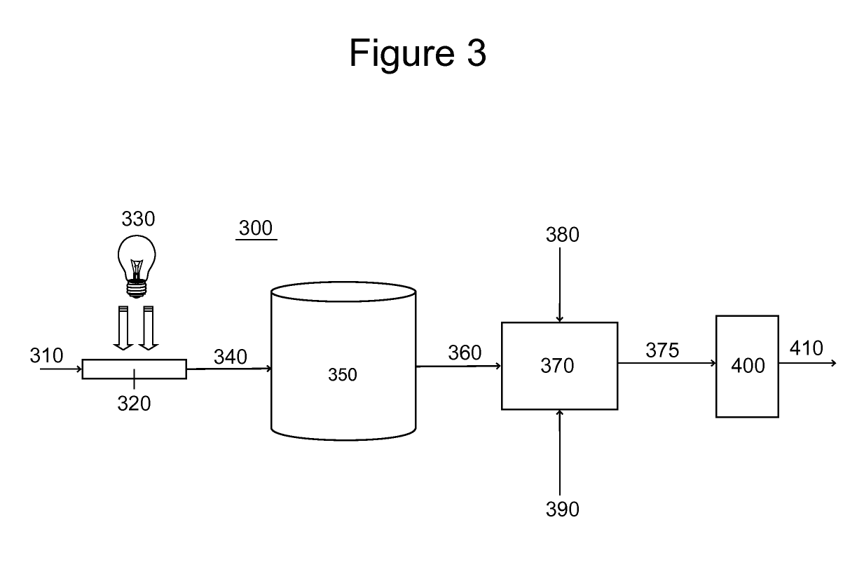

In an embodiment, a process scheme of preparing a polymeric composition containing a SOFE is depicted in FIG. 3. The process may include the steps of contacting styrene monomer, a SOFE, and optionally a diene elastomer in one or more polymerization reactors upstream of a first extruder. Referring to FIG. 3, the process 300 includes contacting a gaseous stream 310 with a light source 330 in the presence of a photocatalyst present in a dry catalyst column 320. The gaseous stream leaving the dry catalyst column, or singlet oxygen stream 340, is then sent to tank 350, wherein a SOFE containing stream 360 is obtained. The SOFE containing stream may be obtained by the process of FIG. 2, wherein tank 350 is the tank 100 of FIG. 2 containing spargers 108. The process may further comprise introducing a diene elastomer containing stream 380 and a styrenic monomer containing stream 390 along with the SOFE containing stream 360 to a reaction zone 370. Suitable conventional elastomers and styrenic monomers have been described previously herein. In an embodiment, the SOFE, the diene elastomer, and the styrenic monomer are fed into the reactor zone from separate feed lines (e.g., a SOFE feed line, a conventional elastomer feed line, and a styrenic monomer feed line). The process may further include contacting the elastomer 380, the SOFE 360, and the styrenic monomer 390 in a mixing apparatus 370 to produce a reaction mixture 375. Contacting of the reagents (e.g., elastomer, SOFE, and styrenic polymer) may be carried out in any order desired by the user and compatible with the process. For example, the reaction mixture 375 may be prepared by initially contacting a diene elastomer with a SOFE and then subsequently contacting with a styrenic monomer. Alternatively, the diene elastomer may be contacted with the styrenic monomer and then subsequently contacted with the SOFE. Alternatively, the SOFE may be contacted with the styrenic monomer and then subsequently contacted with the diene elastomer. In an alternative embodiment, a diene elastomer, a SOFE, and a styrenic monomer are contacted simultaneously, for example within a reaction zone. In such an embodiment, the diene elastomer, the SOFE, and the styrenic monomer may be fed to the reaction zone through separate feed lines (e.g., a SOFE feed line, a diene elastomer feed line, and a styrenic monomer feed line). In some embodiments, one or more additives may be added to the reaction zone. The additives may be added through a separate additive feed line (not shown), alternatively the additives may be pre-contacted with the diene elastomer by adding the additive to the diene elastomer feed line, alternatively pre-contacted with the SOFE by adding the additive to the SOFE feed line, alternatively pre-contacted with the styrenic monomer by adding the additive to the styrenic monomer feed line, or combinations thereof.

The process may further comprise polymerizing the reaction mixture 375 in a reaction zone 400 under conditions suitable for the formation of a polymeric composition 410. During polymerization, a phase separation based on the immiscibility of the styrenic polymer (e.g., polystyrene), the diene elastomer (e.g., polybutadiene), and the SOFE (e.g., photoperoxidized polybutadiene) occurs in two stages. Initially, polybutadiene (both the conventional and photoperoxidized polybutadiene) forms the major or continuous phase with styrene dispersed therein. As the reaction progresses and the amount of polystyrene continues to increase, a morphological transformation or phase inversion occurs such that polystyrene now forms the continuous phase and polybutadiene and styrene monomer form the discontinuous phase. This phase inversion leads to the formation of the discontinuous phase comprising complex elastomeric particles in which the elastomer exists in the form of polybutadiene membranes surrounding occluded domains of polystyrene.

In an embodiment, at least one polymerization initiator is utilized in the polymerization process. In an embodiment, the peroxide groups present on the SOFE serve as internal polymerization initiators. In an alternative embodiment, the polymeric composition production process employs external polymerization initiators. Such external polymerization initiators may function as a source of free radicals to enable the polymerization of styrene. In an embodiment, any initiator capable of free radical formation that facilitates the polymerization of styrene may be utilized. Such initiators can include organic peroxides. In an embodiment, the polymerization initiators are selected from the group of diacyl peroxides, peroxydicarbonates, monoperoxycarbonates, peroxyketals, peroxyesters, dialkyl peroxides, hydroperoxides, and t-butylperoxy isopropyl carbonate, and combinations thereof. In an embodiment, the initiator level in the reaction is given in terms of the active oxygen in parts per million (ppm). In an embodiment, active oxygen level is from 20 ppm to 80 ppm, alternatively from 20 ppm to 60 ppm, alternatively from 30 ppm to 60 ppm. Useful polymerization initiators and their effective amounts have been described in U.S. Pat. Nos. 6,822,046; 4,861,827; 5,559,162; 4,433,099 and 7,179,873, each of which are incorporated by reference herein in their entirety. In an alternative embodiment, the polymerization initiator may be contacted with the other components at any point compatible with the needs of the process.

The polymerization process can be either batch or continuous. In an embodiment, the polymerization reaction may be carried out using a continuous production process in a polymerization apparatus comprising a single reactor or a plurality of reactors. In an embodiment, the polymeric composition can be prepared using an upflow reactor or a downflow reactor or any combinations thereof. One example of reactors and conditions for the production of a polymeric composition are disclosed in U.S. Pat. No. 4,777,210, which is incorporated by reference herein in its entirety.

The polymerization processes of the present disclosure may be operated under any temperature ranges useful in obtaining the polymeric composition as described herein. In one embodiment, the polymerization is operated under temperatures ranging from 90 to 240° C. In another embodiment, the polymerization is operated under temperatures ranging from 100 to 180° C. In yet another embodiment, the polymerization reaction may be carried out in a plurality of reactors, wherein each reactor is operated under an optimum temperature range. In an aspect, the polymerization process may be carried out in a reactor system employing a first and second polymerization reactors that are either continuously stirred tank reactors (CSTR) or plug-flow reactors. In an aspect, a polymerization reactor for the production of the polymeric composition of the type described herein comprising a plurality of reactors, wherein the first reactor (e.g., a CSTR), also known as the prepolymerization reactor, is operated under temperatures ranging from 90 to 135° C. while the second reactor (e.g., CSTR or plug flow) is operated under temperatures ranging from 100 to 165° C. In an aspect, a polymerization process for the production of a polymeric composition as described herein may be carried out in a batch reactor operated at a temperature of 100° C. for two hours, 130° C. for one hour, and 150° C. for one hour.

The polymerized product effluent from the first reactor may be referred to herein as the prepolymer. When the prepolymer reaches a desired conversion, it may be sent to a second reactor for further polymerization. The polymerized product effluent from the second reactor may be further processed as is known to one of ordinary skill in the art and described in detail in the literature. Upon completion of the polymerization reaction, a polymeric composition is recovered and subsequently processed, for example devolatized, pelletized, etc.

End use articles may be obtained from the polymeric compositions of this disclosure. In an embodiment, an article can be obtained by subjecting the polymeric composition to a plastics shaping process such as blow molding, extrusion, injection blow molding, injection stretch blow molding, thermoforming, and the like. The polymeric composition may be formed into end use articles including food packaging, office supplies, plastic lumber, replacement lumber, patio decking, structural supports, laminate flooring compositions, polymeric foam substrate, decorative surfaces, outdoor furniture, point-of-purchase signs and displays, house wares and consumer goods, building insulation, cosmetics packaging, outdoor replacement materials, lids and food/beverage containers, appliances, utensils, electronic components, automotive parts, enclosures, protective head gear, medical supplies, toys, golf clubs and accessories, piping, business machines and telephone components, shower heads, door handles, faucet handles, and the like.

Articles constructed from the polymeric composition of the type described herein may display improved mechanical, physical, and/or optical properties. In an embodiment, the polymeric composition is obtained in the absence of a peroxide initiator and an article constructed from the polymeric composition has improved mechanical, physical, and/or optical properties. In an embodiment, the article constructed from a polymeric composition of the type described herein displays a higher grafting level than an article made from a polymeric composition produced using a peroxide initiator, such as L-233.

### EXAMPLES

### Example 1

Photochemical activation of oxygen in air, with the formation of energy rich photo-excited species singlet oxygen, can occur instantaneously on contact with a photocatalyst in the presence of visible light. Catalyst preparation included dissolving 0.1-0.3 mmol of dye per 100 g of support in water or ethanol and spray coating a support with the resulting solution and subsequently drying.

Singlet oxygen is a metastable species of oxygen and cannot be stored or transported. From the half-life time of singlet oxygen it was estimated that it could travel one or two meters from the point of its formation depending on the airflow rate. Short catalyst columns used for the production of singlet oxygen can be installed close to a feed tank, can be beneficial for the efficient transport of singlet oxygen, and can minimize its deactivation.

The reaction of singlet oxygen in a gas phase with rubber dissolved in styrene in a liquid phase, is heterogeneous and its efficiency depends on the gas-liquid interface. Air diffusers can be used to create small bubbles having a high surface area and increase the efficiency of singlet oxygen reaction with rubber.

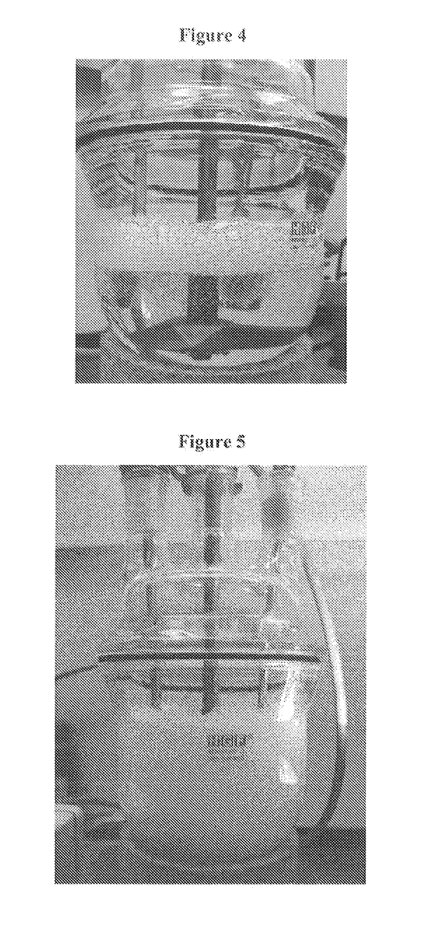

A 400 g of 5 wt % solution of D-55 rubber in styrene monomer was placed in a polymerization kettle equipped with a three-blade stirrer. Two ¾-inch long 15-micron steel air diffusers were placed above the stirrer blades, see FIGS. 4 and 5. The stirrer shear rate was 150-170 rpm. The air diffusers were connected through a T-adapter to the glass column having an inner diameter of 35 mm and a length of 440 mm, which was filled with Rose Bengal dye on a silica extrudate support mixed with 10 mm glass beads. The column was mounted above the reactor horizontally and irradiated with fluorescent light from above and with a halogen lamp from beneath. For the kettle shown in FIG. 5, air was supplied at a rate of 2 liters per minute into the photo-catalyst filled irradiated glass column. This airflow was split between the two air diffusers. The bubbles exiting the air diffusers created fine foam filling the entire reactor volume as shown in FIG. 5.

As the photograph in FIG. 5 shows, air bubbles created by microporous metal air diffusers (spargers) formed dense foam. This foam was characterized by the appearance of a large number of small air bubbles in the styrene feed per unit of volume and is beneficial for the efficiency in this reaction.

The air sparging had an effect on torque. The small bubbles were found to have reduced drag and shear rate as measured by a viscometer with and without diffusing air in the stirred kettle reactor. These results are presented in Table 4:

TABLE 4

| Airflow Rate (L/min) | Shear Rate (rpm) | Torque (Ncm) |
|---|---|---|
| 0 | 175 | 2.36 |
| 2 | 175 | 1.56 |

As shown in Table 4, introducing small bubbles reduces drag and thus torque. This phenomenon is caused by reduced density of the liquid/bubble mixture. Reduced torque is beneficial for the energy savings since drag can be reduced by 50%. In the laboratory experiment with the kettle at 2 L/min airflow, torque was reduced by 44%.

### Example 2

The reacted kettle contents were then subjected to polymerization. The kettle contents were left overnight for 14 hours total, and then polymerized using a standard laboratory HIPS temperature profile of 110° C. for 2 hours, 130° C. for 1 hour and 150° C. for 1 hour. Two batches were polymerized with different feed compositions. The first batch included a 100% photoperoxidized feed and the second batch included a 50/50 blend of photoperoxidized feed with regular, untreated feed as a baseline.

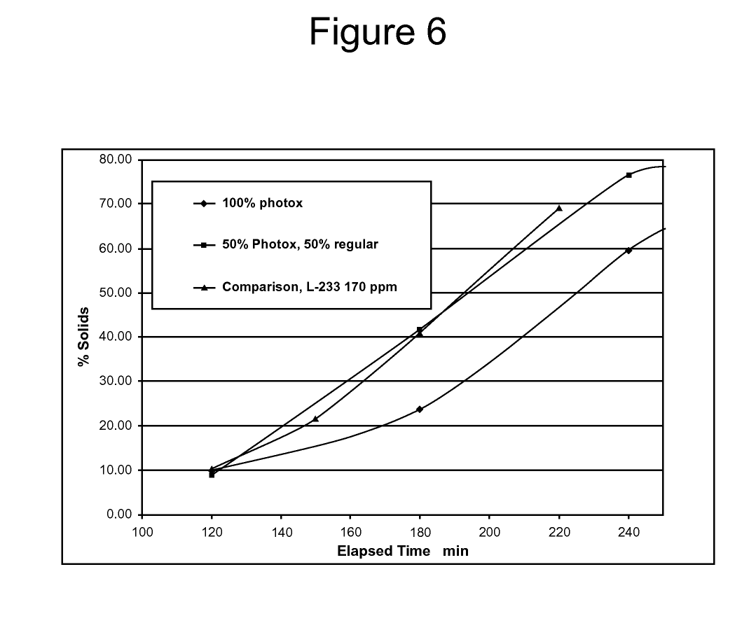

FIG. 6 and Tables 5 and 6 show that the peroxidation level of rubber achieved in the process described herein resulted in a high polymerization rate without the use of any external initiators.

TABLE 5

| Elapsed Time (min) | Baseline w/ L-233 (% solids) |
|---|---|
| 60 | 3.78 |
| 120 | 10.2 |
| 150 | 21.51 |
| 180 | 40.99 |
| 220 | 69.07 |

TABLE 6

| | | 50:50 SOFE:Diene |
|---|---|---|
| Elapsed Time (min) | 100% SOFE (% solids) | Monomer (% solids) |
| 120 | 9.66 | 8.75 |
| 180 | 23.78 | 41.68 |
| 240 | 59.46 | 76.30 |
| 260 | 67.94 | 77.55 |

Tables 5 and 6, list the results in terms of % solids for HIPS obtained by polymerization of a peroxidized rubber feed (100% SOFE) and 50:50 blend of SOFE:diene monomer feed prepared in the stirred kettle reactor without an initiator; and for HIPS obtained with 170 ppm of L-233 initiator, as a comparison. The results show that similar % solids can be obtained when using a peroxidized feed in lieu of an initiator.

The rubber chemistry results in Table 7 show that HIPS obtained by a process including the peroxidation of rubber in a stirred tank reactor can achieve a higher grafting level than that for HIPS obtained by using a commercial peroxide initiator.

TABLE 7

| | | Swell | | % | |
|---|---|---|---|---|---|
| Sample | % Gels | Index | % Rubber | Grafting | Gel:Rubber |
| 100% SOFE | 20.0 | 18.7 | 5.89 | 240.4 | 3.4 |
| 50:50 SOFE:Diene | 14.3 | 14.6 | 5.89 | 143.4 | 2.4 |
| Monomer | | | | | |
| Comparison (Diene | 17.3 | 14.1 | 5.79 | 198.2 | 3.0 |
| Monomer with | | | | | |
| 170 ppm L-233) | | | | | |

The various embodiments of the present invention can be joined in combination with other embodiments of the invention and the listed embodiments herein are not meant to limit the invention. All combinations of aspects of the invention are enabled, even if not given in a particular example herein.

The term “Continuous Stirred-Tank Reactor,” and “Continuously-Stirred Tank Reactor” and “CSTR,” refers to a tank that has a rotor that stirs reagents within the tank to ensure proper mixing; a CSTR can be used for a variety of reactions and processes.

As used herein, the term “diene elastomer” refers to any diene containing elastomer.

As used herein, the term “vessel” refers to a tank, such as a tank reactor, or other holding vessel not including a pipe or other similar conduit for transporting fluids/gases.

It is to be understood that while illustrative embodiments have been depicted and described, modifications thereof can be made by one skilled in the art without departing from the spirit and scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Also, it is within the scope of this disclosure that the aspects and embodiments disclosed herein are usable and combinable with every other embodiment and/or aspect disclosed herein, and consequently, this disclosure is enabling for any and all combinations of the embodiments and/or aspects disclosed herein. Other and further embodiments, versions and examples of the invention may be devised without departing from the basic scope thereof and the scope thereof is determined by the claims that follow.

What is claimed is:

1. A photoperoxidation process comprising:
irradiating a donor molecule with light from a light source to form an activated donor molecule;
contacting the activated donor molecule with an acceptor molecule to form an activated acceptor molecule; and
contacting the activated acceptor molecule with a diene elastomer in a vessel to form a singlet oxygen functionalized elastomer (SOFE) molecule.

2. The process of claim 1, wherein the donor molecule comprises a photosensitizer and the acceptor molecule comprises molecular oxygen.

3. The process of claim 1, wherein the activated acceptor molecule comprises singlet oxygen.

4. The process of claim 2, wherein the photosensitizer comprises a photosensitive dye.

5. The process of claim 4, wherein the photosensitive dye is selected from the group consisting of Rose Bengal, rhodamine B, erythrosin, eosin, fluorescein, methylene blue, and acridine orange, and combinations thereof.

6. The process of claim 1, wherein the light source is selected from the group consisting of an ambient light source, a lamp capable of emitting light having wavelengths from 300 to 1400 nm, and a lamp capable of emitting light having wavelengths from 400 to 750 nm, and combinations thereof.

7. The process of claim 1, wherein the diene elastomer is polybutadiene.

8. The process of claim 1, wherein the diene elastomer is present in the vessel in a styrenic monomer solution.

9. The process of claim 8, wherein the activated acceptor molecule enters the vessel via a sparger positioned in the styrenic monomer solution.

10. The process of claim 9, wherein the sparger comprises microporous air diffusers comprising pore sizes ranging from 0.1 to 20 microns.

11. The process of claim 1, wherein the vessel is a reactor comprising an agitator.

12. The process of claim 1, further comprising polymerizing the SOFE with a styrenic monomer solution to obtain a high impact polystyrene composition.

13. Articles produced from a polymeric product made by a polymerization process that includes the process of claim 12.

14. A high impact polystyrene production process, comprising:
irradiating a photosensitive dye with light from a light source to form an activated photosensitive dye;
contacting the activated photosensitive dye with an oxygen containing gas to form singlet oxygen;
combining the singlet oxygen with a diene elastomer in a styrenic monomer solution in at least one vessel to from a SOFE;
withdrawing a first stream comprising the singlet oxygen functionalized elastomer (SOFE) from the at least one vessel; and
subjecting the first stream to polymerization to obtain a high impact polystyrene composition;
wherein the singlet oxygen enters the vessel via a sparger positioned in the styrenic monomer solution; and wherein the sparger comprises microporous air diffusers comprising pore sizes ranging from 0.1 to 20 microns.

15. The process of claim 14, further comprising combining the first stream comprising a SOFE with a second stream comprising a diene monomer and a third stream comprising styrene monomer prior to the polymerization.

16. The process of claim 14, wherein the high impact polystyrene composition is produced in the absence of a peroxide initiator.

17. The process of claim 14, wherein the first stream comprises a mixture of diene elastomers and SOFEs having a ratio of diene elastomer:SOFE ranging from 1:10 to 10:1.

18. A high impact polystyrene produced by the process of claim 14.

19. The high impact polystyrene of claim 18, having a higher grafting level than high impact polystyrene obtained by a comparable process using a peroxide initiator rather than a SOFE.

20. An article made from the high impact polystyrene of claim 18.
